(19) United States
(12) Patent Application Publication
(10) Pub. No.: US 2003/0236793 A1
(43) Pub. Date: Dec. 25, 2003

(54) Compressed prefix tree structure and method for traversing a compressed prefix tree

(75) Inventor: Tobias Karlsson, Rockville, MD (US)

Correspondence Address: Holly L. Rudnick, Jenkens & Gilchrist, P.C., 3200 fountain Place, 1445 Ross Avenue, Dallas, TX, 75202-2799, US

(73) Assignee: Ericsson Inc., Plano, TX

(21) Appl. No.: 10/175,249

(22) Filed: Jun. 19, 2002

(51) Int. Cl. G06F 17/00

(52) U.S. Cl. 707/101

(57) ABSTRACT

A compressed prefix tree data structure is provided that allows large prefix trees and Virtual Private Network (VPN) trees to be placed in external memory, while minimizing the number of memory reads needed to reach a result. The compressed prefix tree data structure represents one or more bonsai trees, where each bonsai tree is a portion of a prefix tree containing two or more nodes that can be coded into a single data word (codeword). Each codeword is stored in a portion of the external memory (e.g., 16 bytes of DRAM), and retrieved as a unit for processing. Thus, each external DRAM call can retrieve multiple nodes of a prefix tree, reducing the time required for traversing the prefix tree.

### BACKGROUND OF THE INVENTION

1. Field of the Invention

The present invention relates generally to data structures used for data lookups and particularly to tree data structures used for locating data stored in a database.

2. Description of Related Art

There are many ways to search for and locate data stored in a database. For example, if data is stored in a content addressable memory (CAM), data is located based upon the contents of the data instead of the address of a data location in the database. In a CAM, all data locations are processed in parallel to determine the location of particular data within the CAM. Due to the parallel processing, CAMs are expensive and power hungry. In addition, CAMs may not be large enough for certain applications.

For example, one application where CAMs have been used is in Internet Protocol (IP) routing. However, with the growth of the Internet and Virtual Private Networks (VPNs), the number of IP addresses is increasing exponentially. Currently, IP routers need to support approximately 110,000 IP address prefixes (where a prefix is defined as an incremental number of bits of the IP address). In the future, it is predicted that IP routers will need to support up to 500,000 IP address prefixes. In addition, to save IP addresses, certain IP addresses have been allocated as VPN IP addresses that can be re-used between VPN's. For example, a company or other large customer can create a VPN, and allocate VPN IP addresses to each employee or user within the VPN. However, in order to route IP packets using a VPN IP address, the IP router must identify the particular VPN and then access a routing table specific to that VPN. It is predicted that IP routers in the future should be able to support up to 50,000 different VPN routing tables. As the number of IP addresses and VPNs increases, CAMs may no longer be able to effectively or efficiently handle IP routing applications.

Another traditional way to search for and locate data stored within a database is to arrange the data in a tree structure. A tree structure is a data structure having an initial data record (root node) storing pointers to one or more branches extending therefrom towards additional data records (branch nodes) and key values associated with each of the pointers (e.g., one or more bits of an IP address associated with each of the branches). Tree structures are traversed down the branches using a search key until reaching a leaf node that matches the full search key. The leaf node can further contain the desired data or a pointer to the location of the desired data in the database. It should be noted that any node within a tree is a root node with respect to all nodes dependent therefrom, and the dependent nodes are referred to as sub-trees with respect to the root node.

For example, one type of tree structure is a binary tree structure, where each node contains exactly two pointers to two branch nodes depending therefrom, and the key value associated with each pointer is only a single bit. If, for example, an IP address is 32 bits, in order to determine the next-hop (routing) information associated with that IP address, the binary tree would have 32 levels, requiring 32 nodes to be traversed to find a desired IP routing entry. Typically, binary tree structures in IP routing applications are stored in external memory, such as dynamic random access memory (DRAM), requiring a separate DRAM call (read) for each node traversed. Each DRAM call takes a certain amount of time, irregardless of the processor speed. Thus, for IP routing applications, binary tree structures can be bulky, requiring significant memory space and significant searching time.

Another type of tree structure is the prefix tree structure, where each node contains one or more pointers to one or more branch nodes, and the key values associated with each of the pointers is one or more bits. In addition, all of the key values of any node in a sub-tree have a common prefix stored in the root node of that sub-tree. For example, a prefix tree node has the form (A₀K₀) . . . (AᵢKᵢ) . . . (AₙKₙ), where each Aᵢ is a pointer to a sub-tree of that node and each K₁ is a prefix key associated with that sub-tree that identifies only the portion of the full key associated with that sub-tree (and does not include any portion of the full key associated with any previous node).

The prefix tree structure works well in applications where similar data can be grouped together. For example, in IP routing applications, there may be groups of IP addresses that have the same initial bits (e.g., the same initial 4, 8, 16 or 24 bits), and a tree structure can be generated that combines these matching bits to reduce the number of levels. Although the prefix tree structure does not require as many levels or as much memory for storage as the binary tree structure, the prefix tree structure still requires a separate DRAM call for each node, which may be too slow to support required IP routing speeds.

### SUMMARY OF THE INVENTION

To overcome the deficiencies of the prior art, embodiments of the present invention provide a compressed prefix tree data structure that allows large prefix trees and Virtual Private Network (VPN) trees to be placed in external memory, while minimizing the number of memory reads needed to reach a result. The compressed prefix tree data structure represents one or more bonsai trees, where each bonsai tree is a portion of a prefix tree containing two or more nodes that can be coded into a single data word (codeword). Each codeword is stored in a portion of the external memory (e.g., 16 bytes of DRAM), and retrieved as a unit for processing. Thus, each external DRAM call can retrieve multiple nodes of a prefix tree, reducing the time required for traversing the prefix tree.

In one embodiment, a bonsai tree is a representation of a relatively small prefix tree that is divided into twigs consisting of an edge and the node that the edge leads to. Each twig is classified by whether it has a child and whether it has a right sibling. A childless twig is an edge and a node where the node does not have any children. Each twig includes a child flag, a sibling flag, a twig length field and a variable length match field. If the twig has a child, the child flag is set. If the twig has at least one right sibling, the sibling flag is set. The twig length field specifies the length of the prefix key associated with that twig, while the variable length match field includes the prefix key itself. All of the twigs are sorted in a specific order and placed into a sequential twig list within a codeword. For example, the twig list can be formed by traversing the tree depth-first.

In addition to the twig list, the codeword can further include a pointer to an array of next-level codewords. The codewords within the array of next-level codewords can be either child bonsai trees or resulting data. Using a search algorithm to search for a match in a bonsai tree, all twigs in the twig list are processed until reaching a matching childless twig. For each childless twig encountered (whether or not a match), a childless counter is incremented. Upon arriving at the matching childless twig, the childless counter value is returned, and the childless counter value is used as an index into the array to determine the next child bonsai tree or the resulting data.

In further embodiments, for each twig processed that is not a match and that has both a child and a right sibling, an ignore counter can be incremented to keep track of the number of twigs that should be ignored before processing the right sibling of the non-matching twig. If an ignored child has another child or a sibling, the ignore counter can be further incremented to account for all of the twigs that should be ignored until reaching the right sibling of the first non-matching twig.

In still further embodiments, in order to provide a longest prefix matching application, where no matching childless twigs are found within a bonsai tree, a result index of the childless counter can be set to a default index. If the array includes a default codeword, the default index is used to locate the default codeword (e.g., a default route for an IP address) stored in the external memory. If there is no default codeword for a bonsai tree, the search fails.

In hardware implementation embodiments, the compressed prefix tree structure can be traversed by iterating through the bonsai twig list, one at a time, until the match is found, and then determining the next bonsai tree. To improve the performance, in other implementation embodiments, either several processing units or a pipelined processing unit in as many stages as there may be twigs can be used.

Advantageously, by dividing a larger prefix tree into smaller bonsai trees, it is possible to reduce the number of hops that the search algorithm needs to make in order to find a match. Additional advantages of the bonsai tree include that it is compact, flexible and can encode both deep and wide tree structures.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a diagrammatic representation of a bonsai tree, in accordance with embodiments of the present invention;

FIG. 2 illustrates the general format of a data record representing a twig within a bonsai tree;

FIG. 3 illustrates a more specific format of a data record representing a twig within a bonsai tree having various twig lengths;

FIG. 4 illustrates the data structure of a codeword representing the bonsai tree;

FIG. 5 is a flowchart illustrating exemplary steps for generating a twig list within the codeword representing the bonsai tree, in accordance with embodiments of the present invention;

FIG. 6 is a diagrammatic representation of a bonsai tree being traversed to determine a matching childless twig, in accordance with embodiments of the present invention;

FIG. 7 is a flowchart illustrating exemplary steps for traversing a bonsai tree to determine a matching childless twig, in accordance with embodiments of the present invention;

FIG. 8 is a flowchart illustrating exemplary steps for determining the result of a matching twig within of a bonsai tree, in accordance with embodiments of the present invention;

FIG. 9 illustrates the format of an exemplary array of next-level codewords;

FIG. 10 is a diagrammatic representation of a portion of a prefix tree that can be compressed into one or more bonsai trees;

FIG. 11A is a diagrammatic representation of exemplary bonsai trees that can represent the portion of the prefix tree shown in FIG. 10;

FIG. 11B illustrates the interrelation between various exemplary bonsai trees shown in FIG. 11A;

FIG. 12 is a flowchart illustrating exemplary steps for generating one or more bonsai trees from a prefix tree;

FIG. 13 is a diagrammatic representation of default twigs within exemplary bonsai trees;

FIG. 14 illustrates an exemplary array of next-level codewords including a default index to a default twig as shown in FIG. 13;

FIG. 15 is a flowchart illustrating exemplary steps for returning default data associated with a bonsai tree, in accordance with embodiments of the present invention;

FIG. 16 is a schematic block diagram of a computer system for traversing a bonsai tree, in accordance with embodiments of the present invention;

FIG. 17 is a schematic block diagram illustrating a pipelined processor architecture for processing codewords representing bonsai trees; and

FIG. 18 is a logic flow diagram illustrating a pipeline stage for processing a twig of a codeword representing a bonsai tree.

### DETAILED DESCRIPTION OF THE EXEMPLARY EMBODIMENTS

The numerous innovative teachings of the present application will be described with particular reference to the exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

In accordance with embodiments of the present invention, a large prefix tree or a smaller prefix Virtual Private Network (VPN) tree can be represented as one or more bonsai trees, compressed into a compressed prefix tree data structure and placed in an external memory in order to minimize the number of memory reads needed to reach a result. As used herein, the term “bonsai tree” refers to a small prefix tree that is part of a larger prefix tree or that represents an entire small prefix tree that can be coded into a single data word (hereinafter referred to as a codeword).

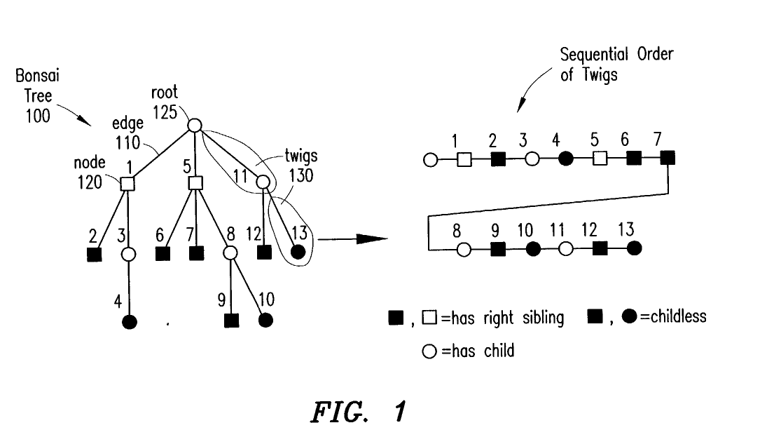

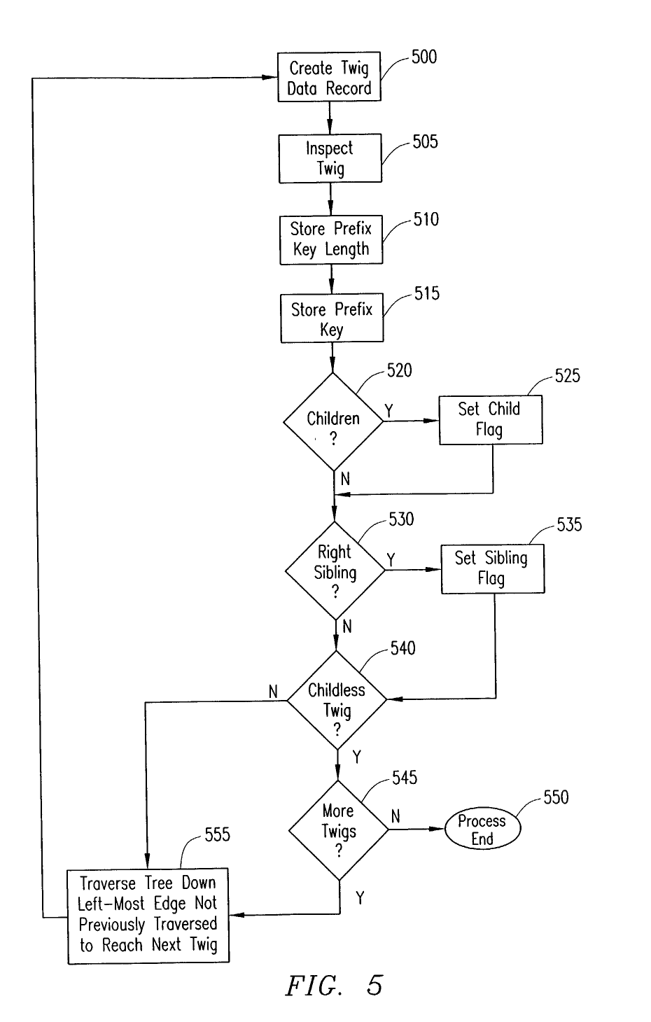

For example, referring now to FIG. 1, there is illustrated an exemplary bonsai tree 100 and the representation of that bonsai tree 100 when coding the bonsai tree 100 into a single codeword (shown in FIG. 4). The bonsai tree 100 illustrated in FIG. 1 has three levels, and thus in a traditional tree structure, up to three DRAM calls would be needed to reach a matching node. However, in accordance with embodiments of the present invention, the entire bonsai tree shown in FIG. 1 can be coded into a single codeword (shown in FIG. 4) having only one level, and thus requiring only one DRAM call.

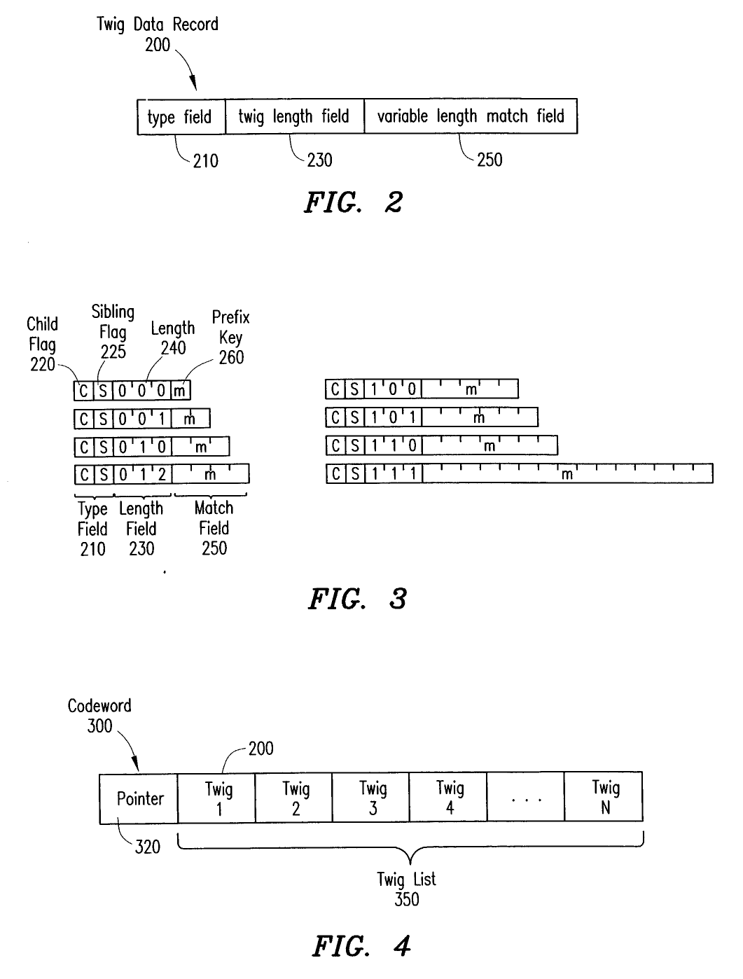

The bonsai tree 100 is divided into twigs 130 consisting of an edge 110 (branch of the bonsai tree 100) and the node 120 that the edge leads to. Each twig 130 is classified by whether it has a child and whether it has a right sibling. A childless twig 130 includes an edge 110 and a node 120 where the node 120 does not have any children. All of the twigs 130 are sorted in a specific order is coded into twig data records (shown in FIG. 2) and placed into a sequential twig list (shown in FIG. 4) within a codeword. For example, the twig list can be formed by traversing the bonsai tree 100 depth-first. As shown in FIG. 1, each twig 130 in the bonsai tree 100 is labeled in the order that the twig data records would be listed in the twig list. In addition, each twig 130 is classified as to whether that twig has a child, has a right sibling or is childless. Each twig data record is only concerned with the left-most child of the twig 130 in the bonsai tree 100. If a twig 130 has more than one child, the other child twigs 130 will be represented as right siblings to each other and to the left-most child in the twig data records. Thus, when coding the twigs 130 into twig data records, each twig data record indicates only one child and/or only one sibling associated with the twig 130. It should be apparent from FIG. 1 that a twig 130 can have both a child and a right sibling or can be childless and have a right sibling.

The general format of a twig data record 200 is shown in FIG. 2. Each twig data record 200 includes a twig type field 210, a twig length field 230 and a variable length match field 250. The twig type field 210 can indicate, for example, whether the twig has a child and/or a sibling. The twig length field 230 specifies the length of a prefix key associated with that twig, while the variable length match field 250 includes the prefix key itself. More specifically, a twig can have any of the formats shown in FIG. 3. The twig type field 210 is illustrated as including a child flag 220 and a sibling flag 225. If the twig has at least one child, the child flag 220 is set. If the twig has at least one right sibling, the sibling flag 225 is set. Various twig lengths 240 are shown, ranging from one bit to fifteen bits in length. Thus, the twig data record 200 format allows prefix keys 260 of lengths of 1, 2, 3, 4, 5, 6, 7 and 15 bits. Any other length can be achieved by cascading several twigs.

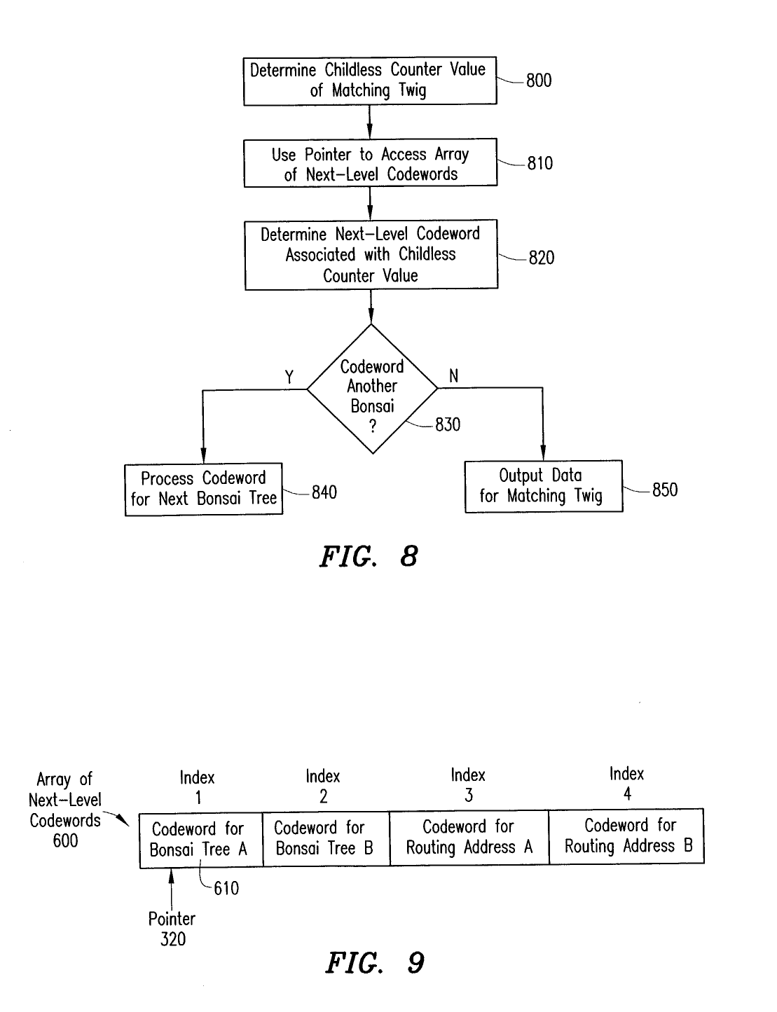

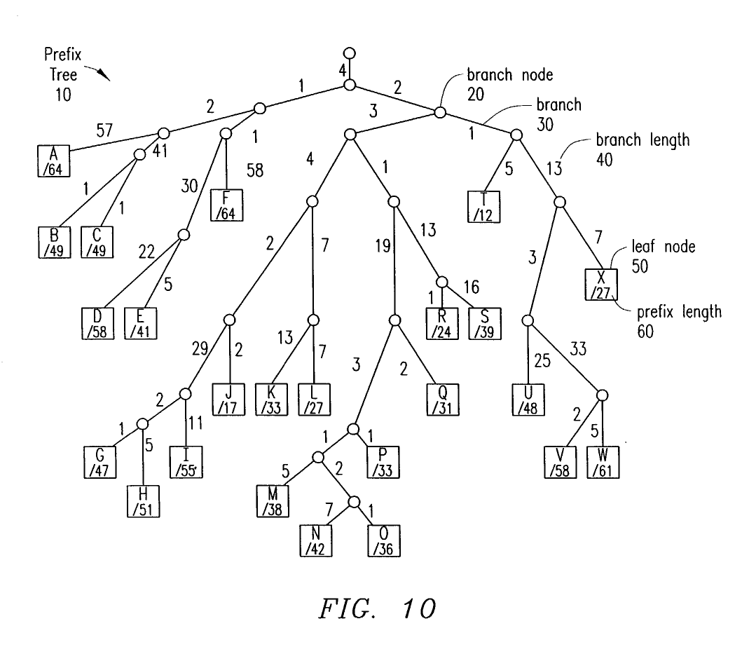

Turning now to FIG. 4, all twig data records 200 representing twigs in the bonsai tree are placed in a sequential twig list 350 within a codeword 300 stored in external memory. In addition to the twig list 350, the codeword 300 can further include a pointer 320 to an array of next-level (child) codewords (shown in FIG. 9). The codewords within the array of next-level codewords can be either child bonsai trees or resulting data (e.g., next-hop or routing information for an IP address). When traversing a bonsai tree by processing the codeword 300, each twig data record 200 representing a childless twig that is encountered is enumerated. When a twig data record 200 representing a matching childless twig within the twig list is reached, the number of the matching childless twig in the twig list is used as an index into the array to determine the next child bonsai tree or the resulting data. For example, referring to the sample bonsai tree shown in FIG. 1 in connection with FIG. 4, the first childless twig 130 is the second twig data record 200 in the twig list 350 and the second childless twig 130 is the fourth twig data record 200 in the twig list 350, and so on. If the search key matches the twelfth twig data record 200 in the twig list 350, which is the seventh childless twig 130, the number seven could be used as an index into the array to determine the next bonsai tree or resulting data associated with the seventh codeword in the array. It should be understood that any enumeration scheme, such as enumerating the first childless twig “0”, the second childless twig “1” and so on, or any other labeling mechanism can be used to determine the next bonsai tree or resulting data associated with the matching childless twig.

FIG. 5 illustrates exemplary steps for generating twig data records within a twig list in accordance with embodiments of the present invention. Each bonsai tree begins with a root node. The first twig data record in the twig list represents the twig that includes the left-most edge extending from the root node and the node that that edge leads to. After the first twig data record is created (step 500), the first twig is inspected (step 505) to determine the length of the prefix key associated with the twig. The length of the prefix key is stored in the first twig data record (step 510) and the prefix key itself is also stored in the first twig data record (step 515).

Thereafter, a determination is made whether the first twig has any children (step 520). If so, a child flag is set (e.g., a child indicator bit is set to “1”) in the twig data record (step 525). In addition, if that first twig has any right siblings (step 530), a sibling flag is set (e.g., a sibling indicator bit is set to “1”) in the twig data record (step 535).

If that first twig is a childless twig (i.e., the child flag is not set) (step 540), a determination is made whether there are any more twigs in the bonsai tree (step 545). If not, the process ends (step 550). If so, or if the first twig is not a childless twig, the bonsai tree is traversed down the left-most edge not previously traversed to locate the next twig (step 555). For example, if the first twig is not a childless twig, the left-most edge would be the edge extending from the first twig towards the left-most child of the first twig. As another example, if the first twig is a childless twig, but has a right sibling, the left-most edge would be the edge extending from the root node toward the right sibling of the first twig. The process is the same for each twig in the bonsai tree (step 500).

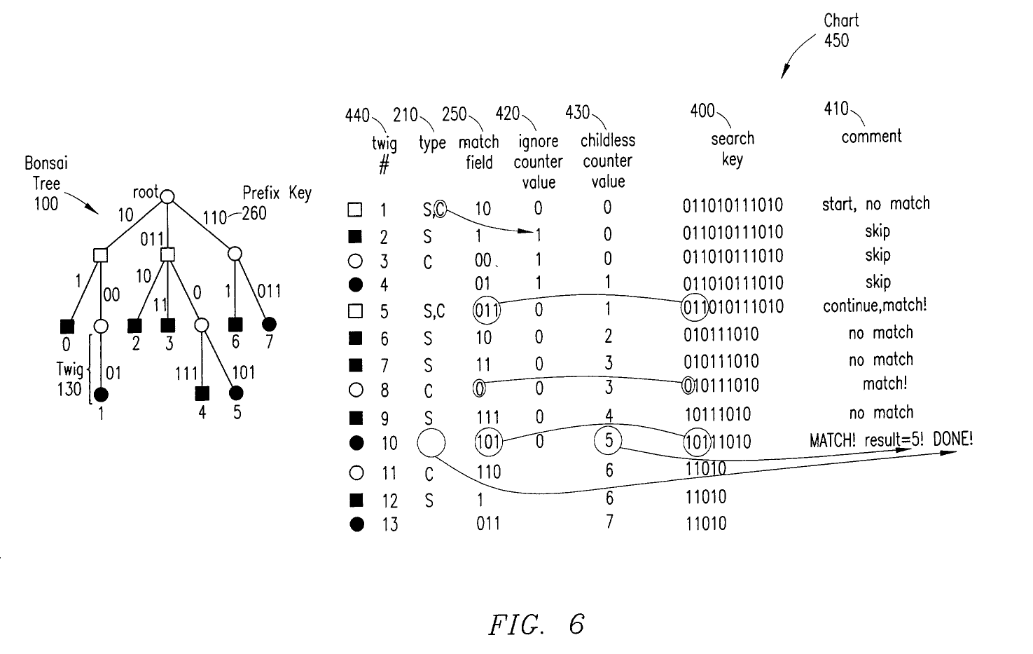

An example of a bonsai tree 100 and a chart 450 illustrating how an associated twig list can be traversed using a search key 400 is shown in FIG. 6. Each twig 130 in the bonsai tree 100 is numbered as shown in FIG. 1. The prefix key 260 associated with each twig 130 is illustrated within the bonsai tree 100 itself shown in FIG. 6, along with the enumeration of each childless twig (from “0” to “7”). The chart 450 includes the twig type field 210 (the child flag and the sibling flag) and the variable length match field 250 of each twig data record (shown in FIG. 2) stored within the twig list (shown in FIG. 4). The chart 450 further lists the twig number 440, a value 420 associated with an ignore counter, a value 430 associated with a childless counter, the search key 400 and comments 410 describing the matching process.

For each twig data record representing a childless twig 130 encountered (whether or not a match), the childless counter value 430 is incremented. In the example shown in FIG. 6, the childless counter value 430 is initialized to “0” upon arriving at the first childless twig 130. As discussed above in connection with FIG. 4, the childless counter value 430 after processing the twig data record representing the matching childless twig 130 is used as an index into the array of next-level codewords to determine the next child bonsai tree or the resulting data. By using a counter, the enumeration of the childless twigs can be performed without requiring an enumeration value to be stored in the twig data record itself. However, it should be understood that in other embodiments, the enumerated value of each childless twig 130 could be stored within the twig data record itself.

Since the twig list is processed in order (without skipping any twig data records), in order to keep track of the number of twig data records that should be ignored (i.e., the number of twigs 130 that will not match based upon a mismatch further up in the tree 100), for each twig data record processed that is not a match and that has a right sibling, an ignore counter value 420 can be incremented if that non-matched twig 130 has a child. If an ignored child has another child or a sibling, the ignore counter value 420 can be further incremented to account for all of the twigs 130 that should be ignored until reaching the right sibling of the first non-matching twig 130.

In the example shown in FIG. 6, the search key 400 is “011010111010”. The match field 250 of the first twig data record in the twig list includes the prefix key “10”. Comparing this to the search key 400, it is readily apparent that the match field 250 of the first twig data record does not match the search key 400 (i.e., the first two bits of the search key are not “10”, but rather “01”). Since the first twig 130 is not a match, all twigs 130 dependent therefrom will also not be a match. Looking at the twig type field 210 for the first twig data record, both the child flag and the sibling flag are set. Since the first twig 130 has a right sibling, there is a possibility that a matching childless twig 130 will be found in the bonsai tree 100. (If the first twig 130 did not have a sibling, there would not be a matching childless twig 130, since all subsequent twigs 130 would be dependent from a non-matching twig 130).

Further, since the child flag in the first twig data record is set, there is at least one child twig 130 that should be ignored. Therefore, upon determining that the match field 250 in the first twig data record does not match the search key 400, the ignore counter value 420 can be incremented (or initialized) to one. Thereafter, when processing the second twig data record in the twig list, with the ignore counter value 420 set to one, the second twig data record in the twig list is ignored (i.e., the prefix key within the match field 250 of the second twig 130 is not compared to the search key 400). After processing and ignoring the second twig data record, the ignore counter value 420 is decremented back to zero.

Although the match field 250 is not compared to the search key 400 during the processing of the second twig data record, the twig type field 210 of the second twig data record is analyzed to determine whether the second twig 130 has a child and/or a right sibling. In this case, the second twig 130 is a childless twig 130, and therefore, in the example shown in FIG. 6, the childless counter value 430 is initialized to zero. In addition, the second twig 130 has a right sibling that should also be ignored (since the right sibling is a child twig 130 of the first twig 130), so the ignore counter value 420 is incremented back to one. The third twig data record in the twig list is the right sibling of the second twig 130. With the ignore counter value 420 set to one, the third twig data record is also skipped, and the ignore counter value 420 is decremented back to zero. The twig type field 210 of the third twig data record indicates that the third twig 130 has a child, so after processing of the third twig 130, the ignore counter value 420 is set back to one.

With the ignore counter value 420 set again to one, the fourth twig data record in the twig list is skipped without comparing the match field 250 of the fourth twig data record to the search key 400. In addition, since the fourth twig 130 is a childless twig 130 without any siblings, after processing the fourth twig data record, the ignore counter value 420 is decremented back to zero and the childless counter value 430 is incremented to one. With the ignore counter value 420 set to zero, the fifth twig data record in the twig list is processed not only to determine the twig type 210, but also to compare the match field 250 in the fifth twig data record to the search key 400. The prefix key 260 within the match field 250 in the fifth twig data record is “011”. As can be seen in FIG. 6, the bits “011” match the first three bits of the search key 400, and therefore, the fifth twig data record matches the search key 400. Therefore, the ignore counter value 420 remains set to zero In addition, upon inspecting the twig type field 210 of the fifth twig data record, it can be seen that the fifth twig 130 has both a child and a sibling. Since the fifth twig 130 is not a childless twig, processing continues.

The sixth twig data record in the twig list is processed to compare the match field 250 to the remaining unmatched bits of the search key 400. The prefix key 260 within the match field 250 of the sixth twig data record is “10”. As can be seen in FIG. 6, the bits “10” do not match the next two bits in the search key 400, which are “01”. Therefore, the sixth twig data record in the twig list is not a match for the search key 400. Since the sixth twig 130 has a sibling, processing continues. However, since the sixth twig 130 does not have a child, the ignore counter value 420 remains set at zero (i.e., there are no child twigs 130 dependent from the non-matching sixth twig 130 that need to be ignored) and the childless counter value 430 is incremented to two. The match field 250 in the seventh twig data record in the twig list also does not match the next bits in the search key 400, and therefore, the seventh twig data record also does not match the search key 400. As with the sixth twig, the seventh twig 130 has a sibling, but no child, so the ignore counter value 420 remains at zero and the childless counter value 430 is incremented to three.

When the eighth twig data record is processed, it is determined that the match field 250 within the eighth twig data record matches the search key 400 (i.e., the prefix key “0” of the eighth twig matches the first remaining bit of the search key “0”). However, since the eighth twig 130 has a child, processing continues to the ninth twig 130. As seen in FIG. 6, the ninth twig data record does not match the search key 400, and since the ninth twig 130 has a sibling, but no child, the ignore counter value 420 remains at zero and the childless counter value 430 is incremented to four. The tenth twig data record in the twig list is the sibling to the ninth twig 130 and the child of the eighth twig 130. In addition, the tenth twig 130 is a childless twig 130, so upon a determination that the match field 250 within the tenth twig data record matches the remaining bits of the search key 400 (i.e., “101”), the childless counter value 430 is incremented to five and the process ends. A result index of five is returned to determine the next bonsai tree or resulting data associated with the matching childless twig 130. For example, in IP routing applications, the IP address (or a certain number of bits of the IP address) is the search key 400, and the result index is used to determine the next bonsai tree (if more bits of the IP address need to be matched) or routing information associated with the IP address (if all bits of the IP address are matched at the end of the bonsai tree).

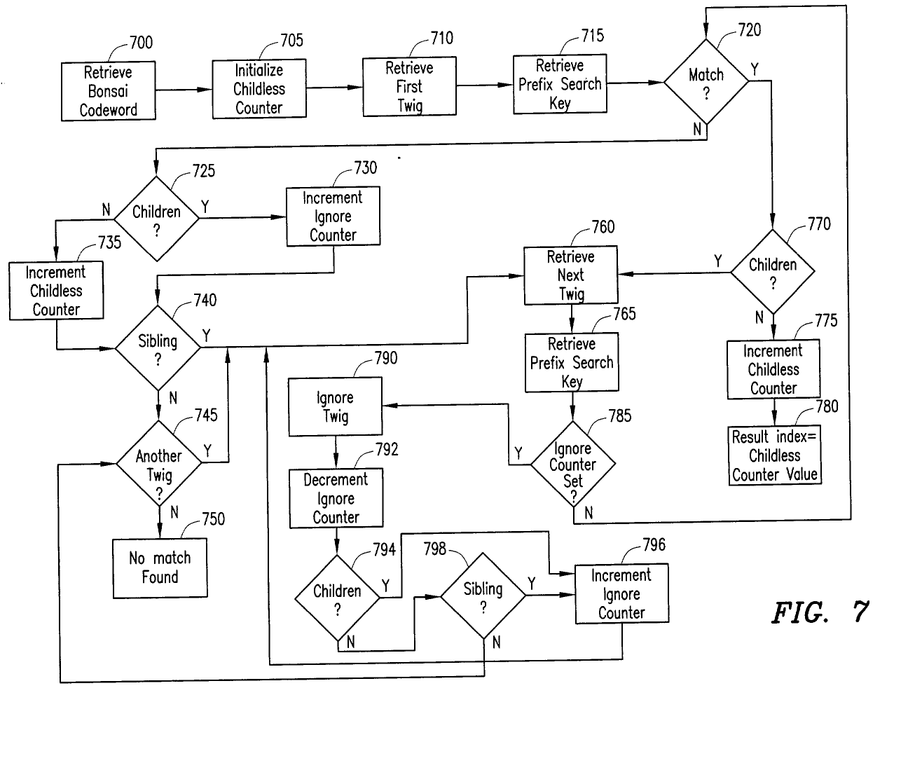

FIG. 7 illustrates exemplary steps for traversing a twig list representing a bonsai tree to determine a matching childless twig. Initially, the bonsai tree codeword is retrieved from external memory for processing (step 700). In some embodiments, the childless counter can be initialized to zero before processing (step 705). In other embodiments, the childless counter can be initialized to zero upon encountering the first childless twig (as shown in FIG. 6). To begin processing, the first twig data record in the twig list within the codeword is retrieved (step 710) and a prefix search key is also retrieved (step 715) to compare the match field (prefix key) within the first twig data record with the search key (step 720).

If the match field within the first twig data record does not match the search key (step 720), the twig type field in the first twig data record is analyzed to determine if the child flag of the first twig is set (step 725). If so, the ignore counter is incremented to one to skip the child of the non-matching first twig (step 730). If not, the childless counter is incremented to count the number of childless twigs within the twig list (step 735). The twig type field is further analyzed to determine if the sibling flag is set (step 740). If not, and the first twig is a childless twig (i.e., there are no more twig data records in the twig list) (step 745), the search fails and no matching childless twig is found (step 750). If the sibling flag is set (step 740), or if the first twig is not a childless twig (i.e., the child flag is set) (step 745), the next twig data record in the twig list is retrieved (step 760), along with the prefix search key (step 765).

However, if the match field within the first twig data record matches the search key (step 720), the twig type field in the first twig data record is analyzed to determine if the child flag is set (step 770). If not, the first twig is a matching childless twig, and the childless counter is incremented by one (step 775). A result index equaling the childless counter value is returned (step 780) to determine the next bonsai tree or resulting data associated with the matching childless twig. If the child flag in the matching first twig data record is set (step 770), the next twig data record in the twig list is retrieved (step 760), along with the prefix search key (step 765).

Once the next twig data record in the twig list is retrieved (whether or not the first twig data record matched the search key) (step 760), and the search key is retrieved (step 765) for comparison with the next twig data record, a determination is made whether the ignore counter is set to one (step 785). If not, the match field within the next twig data record in the twig list is compared to the remaining unmatched bits of the search key to determine if the prefix key within the match field matches the search key (step 720). If the ignore counter is set to one (step 785), the next twig data record in the twig list is ignored (step 790) and the ignore counter is decremented by one (step 792). If the child flag within the next twig data record in the twig list is set (step 794), the ignore counter is again incremented by one (step 796). If the child flag within the next twig data record is not set (step 794), but the sibling flag is set (step 798), the ignore counter is again incremented by one (step 796). However, if neither the child flag nor the sibling flag is set (steps 794 and 798), and there are no more twig data records in the twig list (i.e., the first twig has no more right siblings) (step 745), the process ends and the search fails (step 750). Otherwise, the next twig data record in the twig list is retrieved for processing (step 760), as discussed above.

FIG. 8 illustrates the steps for determining the result of a matching childless twig within of a bonsai tree, in accordance with embodiments of the present invention. The result index returned from the process shown in FIGS. 6 and 7 is the value of the childless counter at the matching childless twig (step 800). The pointer within the codeword is used to access an array of next-level codewords (step 810), and the result index is used to access a particular codeword within the array of next-level codewords associated with the matching childless twig (step 820). If the next-level codeword associated with the result index represents another bonsai tree (step 830), that next-level codeword is processed to determine the matching childless twig (if any) from that next-level codeword (step 840). However, if the next-level codeword associated with the result index is resulting data, the data is output (step 850).

An example of an array of next-level codewords 600 is demonstrated in FIG. 9. Each codeword representing a bonsai tree includes not only the twig list, but also a pointer 320 that points to an associated array of next-level codewords 600. Each codeword 610 within the array of next-level codewords 600 is a separate data structure having a size equivalent to the original (root) codeword. The value of the childless counter at the matching childless twig is used as an index to determine the appropriate next-level codeword 610 for the matching childless twig. For example, if the value of the childless counter at the matching childless twig is one (e.g., the result index is “1”), the first next-level codeword 610 in the array 600 (e.g., the codeword 610 that the pointer 320 points to) would be accessed to retrieve the codeword 610 for “Bonsai Tree A”. However, if the value of the childless counter at the matching childless twig is three (e.g., the result index is “3”), the third next-level codeword 610 in the array 600 would be accessed to retrieve the codeword 610 for “Routing Address A” to output the routing address for the next-hop of an IP packet. The array 600 includes as many next-level codewords 610 as there are matching childless twigs.

In addition, the array 600 can further include a default codeword (shown in FIG. 14) to implement a longest matching prefix application if there are no matching childless twigs within that particular bonsai tree, but there is a default route for the IP packet. For example, in some routing scenarios, a default route can be applied to IP packets where the destination IP address has a certain number of matching bits before the non-matching bonsai tree was traversed.

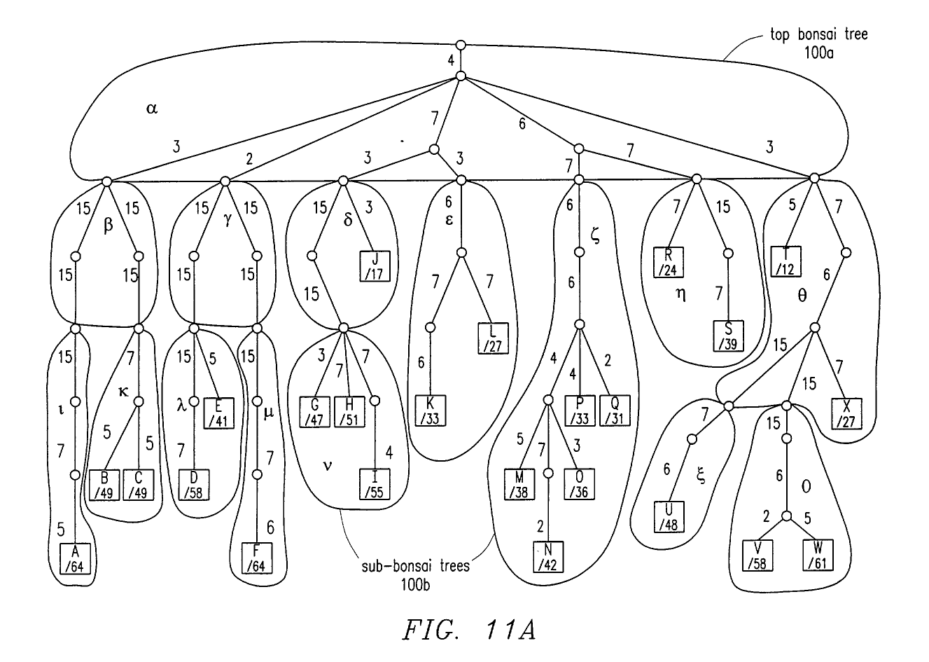

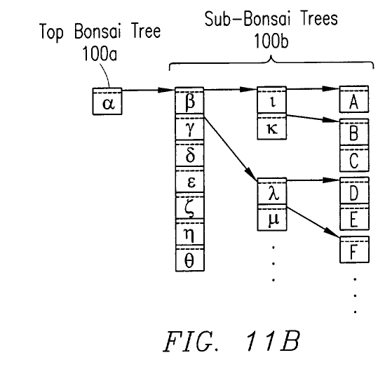

FIGS. 10, 11A and 11B illustrate an example of how a large prefix tree can be divided into multiple bonsai trees. FIG. 10 shows a prefix tree 10 with 24 leaf nodes 50 (labeled A-X). The longest matching prefix in this example is 64 bits (leaf node A). Each branch node 20 in the tree 10 contains both pointers to one or more branches 30 extending therefrom towards additional branch nodes 20 and prefix keys (not shown) associated with each of the pointers to determine which branch 30 to use. The branch length 40 is the number of bits that needs to be matched in order to propagate further down through the tree 10. It should be noted that the sum of branch lengths 40 on the path to a matching leaf node 50 equals the prefix length 60. The prefix tree 10 has a hierarchy depth of up to nine levels, thus requiring up to nine DRAM calls to determine a matching leaf node 50.

The prefix tree 10 shown in FIG. 10 can be converted into a tree structure of bonsai trees 100, as shown in FIG. 11A. As discussed above, in one embodiment, each twig data record within the twig list of a codeword representing the bonsai tree contains a match field that has a variable length of not more than a maximum number of bits (e.g., 15 bits). Therefore, any branch lengths 40 in the prefix tree 10 greater than the maximum number of bits should be broken down into segments of not more than the maximum number. In addition, branches of the prefix tree (or portions of branches of the prefix tree) can be combined to maximize the length of the bonsai tree branches (twigs). As can be seen in FIG. 11A, the top bonsai tree 100a is labeled α, and all other sub-bonsai trees 100b depend from the top bonsai tree 100a. The branches 30, branch nodes 20 and branch lengths 40 in the prefix tree 10 in FIG. 10 have been modified in FIG. 11A into twigs, without changing the result of any search of the prefix tree 10. In FIG. 11A, fifteen bonsai trees 100a and 100b are used to represent the prefix tree 10 at a hierarchy depth of three levels. Thus, by converting the prefix tree 10 to bonsai trees 100a and 100b, the number of potential DRAM calls can be reduced from nine to three, saving memory bandwidth.

The interrelation between the bonsai trees 100a and 100b is illustrated in FIG. 11B. The codeword representing the top bonsai tree 100a (α) includes a pointer to an array of next-level codewords, where each next-level codeword in the array represents one of the following sub-bonsai trees 100b: β, γ, δ, ε, ζ, η and θ. Each of the sub-bonsai trees 100b can further have a pointer to an additional array of next-level codewords representing further sub-bonsai trees 100b. For example, the β sub-bonsai tree points to an array containing next-level codewords representing sub-bonsai trees τ and κ. The sub-bonsai tree τ includes leaf node A from the original prefix tree, while the sub-bonsai tree κ includes leaf nodes B and C from the original prefix tree.

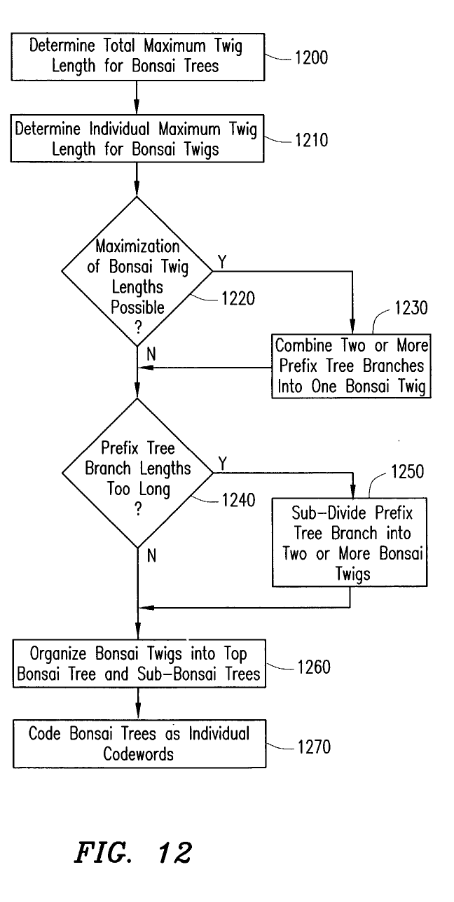

FIG. 12 illustrates exemplary steps for converting a prefix tree to one or more bonsai trees. Once a determination is made of the total maximum length for all bonsai twigs within a bonsai tree (to ensure that all twig data records fit into a single codeword) (step 1200) and the individual maximum twig length of individual twigs within a bonsai tree (to ensure that each twig data record is no more than a certain length) (step 1210), software can be used to determine whether maximization of bonsai twig lengths is possible (step 1220). For example, in FIG. 10, the branch length of the left-most branch in the prefix tree is only one bit, and the node extending from the left-most branch has two branches, each having small branch lengths (1 bit and 2 bits). To maximize the twig length within a bonsai tree, the first branch node on the left-hand side of the prefix tree can be removed, leaving two branches from the root node, one having three bits and one having two bits, as shown in FIG. 11A. Effectively, the bonsai tree has combined the first branch with each of the sub-branches to remove a branch node, thus further improving compression of the prefix tree. Therefore, if maximization is possible, software combines two or more branches (or parts of two or more branches) (step 1230), so that the twig length of each twig data record is maximized.

In addition, software also determines whether any of the branch lengths of the prefix tree are too long for the bonsai tree (step 1240) (e.g., whether a branch length exceeds the individual maximum twig length for a bonsai branch). For example, in FIG. 10, the branch length of the branch leading towards leaf node A is 57. If, for example, the maximum twig length is 15, the branch leading towards leaf node A would have to be divided into sub-branches (and sub-branch nodes) to ensure that each twig length is no more than fifteen. This can be easily seen in FIG. 11A, where the branch leading to leaf node A has been sub-divided into five branches. Thus, if there are branches in the prefix tree that have branch lengths that exceed the maximum individual branch length for a bonsai branch, that branch is sub-divided into two or more bonsai twigs (step 1250), so that no single bonsai twig exceeds the maximum individual twig length. The process of sub-dividing and maximizing is performed dynamically to create the most efficient bonsai trees.

Once the maximizing and sub-dividing processes are completed, the bonsai twigs are organized into bonsai trees (step 1260). The bonsai trees are interrelated, such that there is a top bonsai tree and one or more sub-bonsai trees depending therefrom. Once the bonsai trees have been formed, each bonsai tree can be coded as a single codeword (step 1270) and stored in external memory, along with the appropriate pointers to sub-bonsai trees.

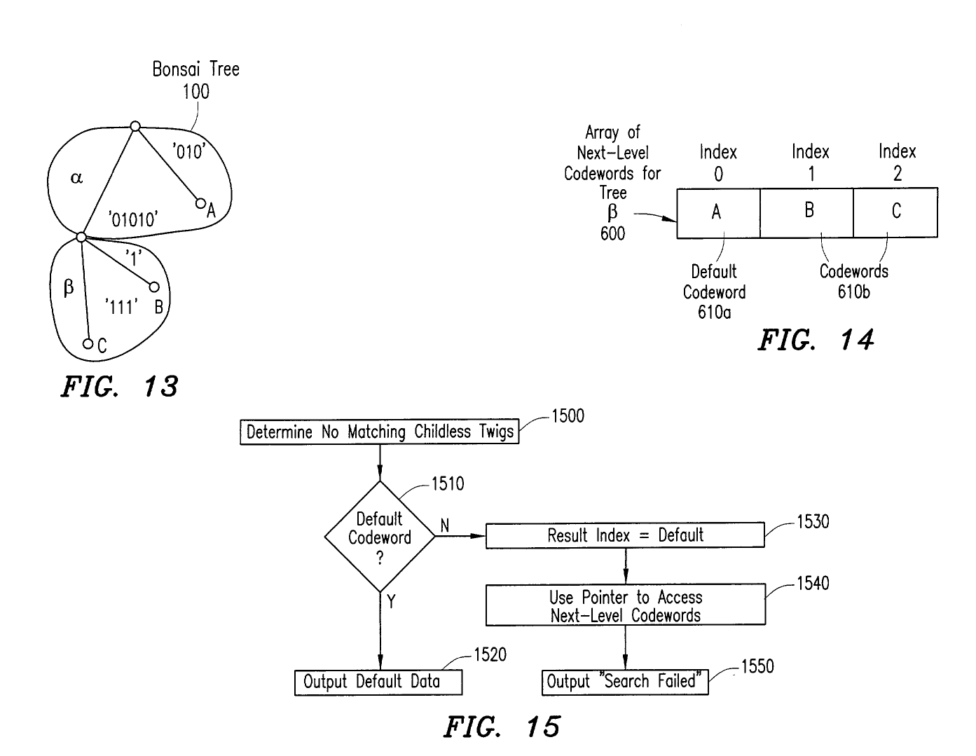

As discussed above in connection with FIG. 9, in order to provide a longest matching prefix application, the array of next-level codewords can include a default codeword representing default data (e.g., a default route for an IP packet) when there are no matching childless twigs within a bonsai tree. A search for the longest matching prefix is needed when there are several prefixes matching the same address. For example, as shown in FIG. 13, if the leaf nodes of the larger prefix tree have the prefix keys “010”, “010101” and “01010111”, the larger prefix tree can be divided into two bonsai trees 100 (α and β). Since “010” has the same beginning as “010101” and “01010111”, but is shorter, the “010” prefix should be placed so that it is searched last. Further, the search might continue into the β bonsai tree, so there should also be a way to default back to the “010” prefix key (leaf node) in the α bonsai tree if no match is found in the β bonsai tree.

If no match is found in the α bonsai tree, the search fails. However, if the search key matches the first childless twig in the top (α) bonsai tree (having the “01010” prefix key), the result index associated with the first matching childless twig would be associated with a pointer to the second (β) bonsai tree. Without a default codeword in the array of next-level codewords pointed to by the pointer in the root codeword representing the β bonsai tree, if the search key does not match any of the childless twigs in the second bonsai tree, the search would also fail and no resulting data would be returned.

However, as shown in FIG. 14, with a default codeword 610a in the array 600 associated with the β bonsai tree, the search would not fail, and resulting data associated with the longest matching prefix can be returned. For example, in FIGS. 13 and 14, the default codeword 610a in the array 600 of the β bonsai tree includes the same resulting data associated with the second childless twig (A leaf node) of the α bonsai tree. The default codeword 610a in FIG. 14 is the first codeword in the array 600 (e.g., the codeword that the pointer in the root codeword would point to) for the β bonsai tree. In the example of FIG. 14, a result index of “0” is used to index on the first codeword 610a in the array to retrieve the default codeword 610a. Other codewords 610a in the array represent other bonsai trees or resulting data.

In one embodiment, the childless counter can be incremented to one or initialized to one upon encountering the first childless twig data record in the twig list, and if no childless twig data records within the twig list match the search key, default logic can decrement or re-initialize the childless counter to zero. Alternatively, default logic can be programmed to return a pre-set default result index. In another embodiment, in the case where all bonsai trees do not include default data, a default flag (not shown) could be included in the codeword, along with the pointer and twig list, to indicate whether or not a default codeword 610a in the array of next-level codewords 600 exists, and if so, the number (index) of the default codeword 610a could also be coded into the codeword or default logic can be programmed to return a pre-set result index for the number of the default codeword 610a (e.g., index 0).

FIG. 15 illustrates exemplary steps for returning default data associated with a bonsai tree, in accordance with embodiments of the present invention. If there is no matching childless twig data record within a twig list associated with a bonsai tree (step 1500), a determination is made whether the bonsai tree has default data associated therewith (step 1510). For example, a default flag can indicate whether or not the bonsai tree has default data or all bonsai trees can have default data associated therewith. If not, the search fails (step 1520). However, if there is default data, a default result index is returned (step 1530), as described above in connection with FIG. 14 (e.g., result index =0). Thereafter, the pointer within the codeword representing the bonsai tree is used to access the array of next-level codewords (step 1540) to determine the default codeword and retrieve default data for the search (e.g., a default route for an IP packet) (step 1550).

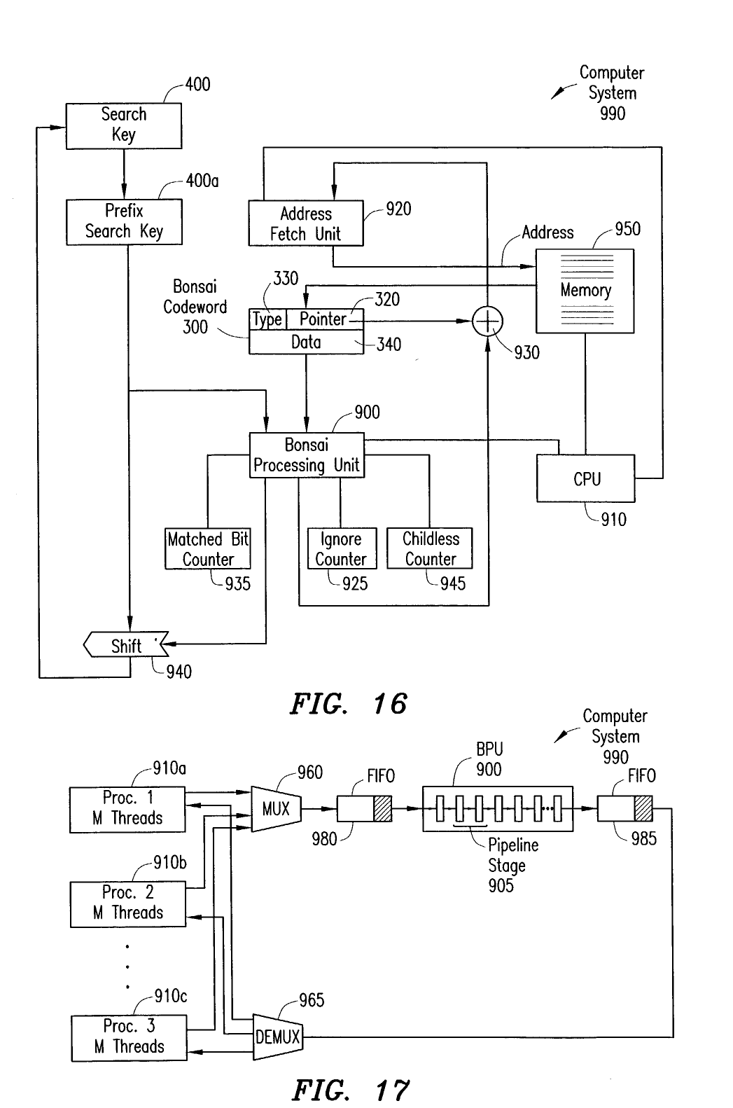

Turning now to FIGS. 16-19, there is illustrated a computer system 990 for processing the bonsai trees of the present invention. In FIG. 16, the computer system 990 includes a processor 910 (which can be any microprocessor or microcontroller) operatively connected to a bonsai processing unit (BPU) 900 that is configured to process bonsai trees. The BPU 900 functions as a co-processor that is hard-wired to perform the task of processing bonsai trees. The BPU 900 is further operatively connected to an external memory 950 (e.g., DRAM) that permanently stores the codewords 300 representing the bonsai trees.

During the execute stage, the CPU 910 loads a codeword 300 from memory 350. The codeword 300 has a type field 330 that indicates either that the search is completed, and if so, the result of the search (e.g., IP address for the next-hop) is the remaining part of the loaded data 340 in the codeword 300, or that the loaded data 340 in the codeword 300 is a bonsai tree (e.g., twig list 350 shown in FIG. 4), in which case, processing continues. The codeword 300 may also further include a pointer 320 (if the loaded data 340 is a bonsai tree). The CPU 910 feeds the codeword 300 and a prefix search key 400a representing the portion of the search key that still needs to be matched to the BPU 900 for processing. The BPU 900 further accesses an ignore counter 925, a matched bit counter 935 and a childless counter 945 to increment and decrement the counters 925, 935, 945, as discussed above, during processing of a codeword 300.

The BPU 900 outputs whether or not a match has been found by returning a result index 430 corresponding to the matching twig (or default data). The result index 430 and pointer 320 of the codeword 300 are input to an adder 930 that adds the result index 430 to the pointer 320 to form the pointer to the next codeword 300 in memory 950. An address fetch unit 920 uses the resulting pointer to locate and retrieve the next codeword 300 for processing by the BPU 900. The BPU 900 further outputs the matched bit count 970, which is used by shifting logic 940 to shift the search key 400 for the next iteration.

It should be understood that most memory 950 interfaces have an optimal minimum transfer size (OMTS). Any transfer smaller than the OMTS will require as much time of the memory interface as an OMTS transfer. Therefore, in one embodiment, if the external memory 950 is DRAM, each codeword 300 is stored in 16 bytes of DRAM (16 bytes is typically the OMTS for DRAM). Therefore, by storing the codewords 300 in 16 byte segments, each codeword 300 takes the same amount of time to be read out of DRAM. Further, since each codeword 300 includes multiple childless twigs (leaf nodes of a larger prefix tree), all of which are read out of DRAM simultaneously, the time for processing a larger prefix tree is significantly reduced. Thus, during execution, the BPU 900 can receive a 128 bit word consisting of 96 bits for the codeword (with one bit for the default flag and 95 bits for the twig list) and 32 bits for the search key.

In one implementation embodiment, the codeword 300 representing the bonsai tree can be traversed by iterating through the twig list, one at a time, until a match is found, and then determining the next bonsai tree. To improve the performance, in other implementation embodiments, either several processing units or a pipelined processing unit in as many stages as there may be twigs can be used. The latter pipelined processor architecture is illustrated in FIG. 17.

In FIG. 17, the BPU 900 processes codewords in pipeline stages 905. Each pipeline stage 905 processes one of the twigs within a codeword. As an example, if a codeword has 14 twigs, the BPU 900 processes one of the 14 twigs in each pipeline stage. Thus, with a pipelined processor architecture, one twig data record in a codeword can be processed at each clock cycle, even at very high clock frequencies. The BPU 900 can further be fed with a new codeword 300 every clock cycle to enable the BPU 900 to process multiple codewords simultaneously. As an example, the first pipeline stage within the BPU 900 can process the first twig of each codeword, the second pipeline stage can process the second twig of each codeword, and so on.

Typically, each codeword 300 currently being processed by the BPU 900 originates from a different context (thread) of the CPU 910 or from different CPUs (e.g., CPU's 910a, 910b and 910c) within a multi-processor system (or a combination of these). The codewords 300 are multiplexed by multiplexer 960 and stored in an input first-in-first-out (FIFO) buffer 980 for input to the pipelined BPU 900. The result produced by the BPU 900 is stored in an output FIFO 985 before being demultiplexed by demultiplexer 965 and passed back to the originating thread 910a, 910b . . . 910c.

In one embodiment, each pipeline stage is around 6 Kgates in size and runs at frequencies up to 500 MHz. If the number of pipeline stages is increased to 16, the total pipeline size would be around 100-150 Kgates. At a frequency of 500 MHz, the 16-stage pipelined processor would be capable of processing 10 bonsai trees per IP packet at an IP packet rate of 50 Mpps.

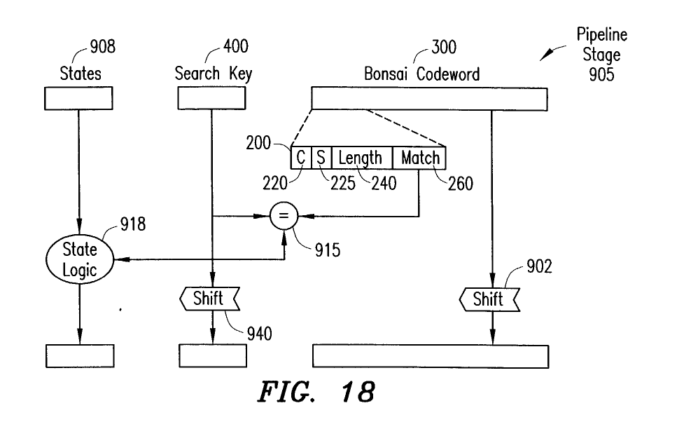

FIG. 18 illustrates a pipeline stage 905 for processing a twig 200 of a codeword 300 representing a bonsai tree. Each pipeline stage 905 processes a separate twig 200 of the codeword 300, and at the end of processing, shifting logic 902 shifts to the next twig 200 in the codeword 300 for the next pipeline stage 905. The twig 200 and the search key 400 are compared by comparison logic 915 to determine if the prefix key 260 associated with the twig 200 matches the search key 400 If a match is found, shifting logic 940 shifts the search key 400 for the next pipeline stage 905. Otherwise, the same search key 400 is passed to the next pipeline stage 905. The comparison logic 915 further processes the child flag 220 and sibling flag 225 to update the ignore counter value and childless counter value, accordingly. Several states 908 are further passed along with each stage and provided to the comparison logic 915 by state logic 918 for processing of the twig 220. For example, such states 908 can include the ignore counter value, the childless counter value, the matched bit counter value and a small state word specifying whether the search is still going on or is done (e.g., the search failed or a matching childless twig has been found).

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. In a memory storing a compressed prefix tree data structure, the compressed prefix tree data structure comprising:
a codeword representing at least a portion of a prefix tree, the portion covering two or more nodes of the prefix tree; and
a list of data records within said codeword, each of said data records within said list having a variable length match field therein storing a prefix key, each said prefix key being associated with a respective twig consisting of an edge and a select one of the two or more nodes that the edge leads to, said list of data records including said prefix key for each said respective twig within the portion of the prefix tree covered by said codeword.

2. The compressed prefix tree data structure of claim 1, wherein each of said data records has a twig type field therein indicating whether said select node of said respective twig has at least one child node and whether said select node of said respective twig has at least one right sibling node.

3. The compressed prefix tree data structure of claim 2, wherein each said twig type field has a child flag and a sibling flag therein.

4. The compressed prefix tree data structure of claim 3, wherein said child flag represents the left-most child node of said select node of said respective twig.

5. The compressed prefix tree data structure of claim 1, wherein each of said data records further has a twig length field therein indicating the length of said respective prefix key.

6. The compressed prefix tree data structure of claim 1, further comprising:
a pointer within said codeword pointing to an array of next-level codewords for each said twig represented by said list of data records that does not have a child.

7. The compressed prefix tree data structure of claim 6, wherein each said next-level codeword within said array of next-level codewords represents an additional portion of said prefix tree or resulting data.

8. The compressed prefix tree data structure of claim 6, wherein said array of next-level codewords further includes a default codeword representing default data.

9. The compressed prefix tree data structure of claim 8, wherein said default data is associated with an additional node outside of the portion of the prefix tree covered by said codeword.

10. The compressed prefix tree data structure of claim 1, wherein said codeword represents a bonsai tree, said bonsai tree representing the portion of the prefix tree covered by said codeword.

11. The compressed prefix tree data structure of claim 10, wherein each said edge associated with said respective twig is a branch of said bonsai tree.

12. A method for generating a compressed prefix tree structure, comprising the steps of:
creating a codeword within a memory, said codeword representing at least a portion of a prefix tree, the portion covering two or more nodes of the prefix tree; and
storing a list of data records within said codeword, each of said data records within said list having a variable length match field therein storing a prefix key, each said prefix key being associated with a respective twig consisting of an edge and a select one of the two or more nodes that the edge leads to, said list of data records storing said prefix key for each said respective twig within the portion of the prefix tree covered by said codeword

13. The method of claim 12, wherein said step of storing further comprises the step of:
providing a twig type field within each of said data records, each said twig type field indicating whether said select node of said respective twig has at least one child node and whether said select node of said respective twig has at least one right sibling node.

14. The method of claim 13, wherein said twig type field has a child flag and a sibling flag therein, said step of storing further comprising the steps of:
setting said child flag for each of said data records where said select node associated with said respective twig has at least one child node; and
setting said sibling flag for each of said data records where said select node associated with said respective twig has at least one right sibling node.

15. The method of claim 12, wherein said step of storing further comprises the step of:
storing within each of said data records a twig length field indicating the length of said prefix key.

16. The method of claim 12, further comprising the step of:
storing a pointer within said codeword that points to an array of next-level codewords for each said select node associated with said respective twig that does not have a child.

17. The method of claim 16, wherein each said next-level codeword within said array of next-level codewords represents an additional portion of said prefix tree or resulting data.

18. The method of claim 16, wherein said array of next-level codewords further includes a default codeword representing default data, said default data being associated with an additional node outside of the portion of the prefix tree covered by said codeword.

19. The method of claim 12, wherein said codeword represents a bonsai tree, said bonsai tree representing the portion of the prefix tree covered by said codeword, each said edge associated with said respective twig being one of a plurality of branches of said bonsai tree, and wherein said step of storing further comprises the steps of:
traversing said bonsai tree down a left-most one of said plurality of branches until reaching a first one of said two or more nodes;
creating a first one of said data records associated with a first twig including said left-most branch and said first node; and
storing said first data record in a first position within said codeword.

20. The method of claim 19, wherein said step of storing further comprises the steps of:
traversing said bonsai tree down an additional left-most one of said plurality of branches not previously traversed until reaching an additional one of said two or more nodes;
creating an additional one of said data records associated with an additional twig including said additional left-most branch and said additional node;
storing said additional data record in a sequential position within said codeword behind said first position; and
repeating said steps of traversing, creating and storing for each of said plurality of branches within said bonsai tree.

21. A method for generating one or more bonsai trees from a prefix tree comprised of a plurality of branches leading to a plurality of branch nodes, each of said branches having a branch length associated therewith indicating a number of bits needed to be matched in order to propagate down towards said branch node that said respective branch leads to, said method comprising the steps of:
determining a maximum total twig length for all twigs within each of said one or more bonsai trees, each of said twigs including an edge and a node that the edge leads to; and
dividing said prefix tree into said one or more bonsai trees such that the sum of said branch lengths of all of said branches of said prefix tree included within each of said one or more bonsai trees is less than said maximum total twig length.

22. The method of claim 21, wherein said step of dividing further comprises the step of:
creating a top bonsai tree and one or more sub-bonsai trees dependent from said top bonsai tree.

23. The method of claim 21, wherein each of said twigs within said one or more bonsai trees has an individual maximum length, and wherein said step of dividing further comprises the step of:
sub-dividing a select one of said branches of said prefix tree into two or more of said twigs when said branch length of said select branch exceeds said individual maximum length.

24. The method of claim 23, wherein each of said branches of said prefix tree has a prefix key associated therewith, and wherein said step of dividing further comprises the step of:
combining at least part of said prefix key of two or more of said branches of said prefix tree within a single one of said twigs to maximize the length of each of said twigs up to said individual maximum length.

25. A computer system for traversing a bonsai tree representing at least a portion of a prefix tree, the portion covering two or more nodes of said prefix tree, said computer system comprising:
a memory for storing a codeword representing said bonsai tree, said codeword having a list of data records therein, each of said data records within said list having a variable length match field therein storing a prefix key, each said prefix key being associated with a respective twig consisting of an edge of said bonsai tree and a select one of the two or more nodes that the edge leads to, said list of data records including said prefix key for each said respective twig within the portion of the prefix tree covered by said codeword; and
a processing unit connected to retrieve said codeword from said memory in a single memory read operation and process said codeword using a search key.

26. The computer system of claim 25, wherein said processing unit is configured to process each of said data records within said codeword in a sequential order.

27. The computer system of claim 26, wherein each of said data records has a twig type field therein containing a child flag indicating whether said select node of said respective twig has at least one child node and a sibling flag indicating whether said select node of said respective twig has at least one right sibling node.

28. The computer system of claim 27, wherein said processing unit is operable to compare each said prefix key within each of said data records with said search key.

29. The computer system of claim 28, wherein said processing unit is further operable to determine whether said prefix key within a first one of said data records matches said search key.

30. The computer system of claim 29, wherein said processing unit is further operable to ignore a next one of said data records in said sequential order when said child flag and said sibling flag of said first data record are set and said prefix key within said first data record does not match said search key.

31. The computer system of claim 30, wherein said processing unit is further operable to ignore an additional one of said data records in said sequential order when said child flag of said next data record is set or said child flag of said next data record is not set, but said sibling flag of said next data record is set.

32. The computer system of claim 31, further comprising:
an ignore counter, said processing unit being operable to increment said ignore counter when said child flag and said sibling flag of said first data record are set and said prefix key within said first data record does not match said search key, decrement said ignore counter after processing said next data record, increment said ignore counter when said child flag of said next data record is set or said child flag of said next data record is not set, but said sibling flag of said next data record is set and decrement said ignore counter after processing said additional data record.

33. The computer system of claim 32, wherein said processing unit is further operable to process said next data record and said additional data record by analyzing said twig type field without comparing said prefix key within said next data record and said additional data record with said search key.

34. The computer system of claim 28, wherein said processing unit is further operable to enumerate each of said data records where said child flag is not set.

35. The computer system of claim 34, wherein said codeword further includes a pointer for pointing to an array of next-level codewords for each said of said data records that does not have said child flag set, each said next-level codeword within said array of next-level codewords representing an additional bonsai tree of said prefix tree or resulting data.

36. The computer system of claim 35, wherein said processing unit is further operable to return a result index indicating the number of a matching one of said data records having said child flag not set that matches said search key, said result index being used to determine said next-level codeword within said array of next-level codewords associated with said matching data record and retrieve said next-level codeword associated with said matching data record.

37. The computer system of claim 36, wherein said array of next-level codewords further includes a default codeword representing default data, said default data being associated with an additional node outside of the portion of the prefix tree covered by said codeword.

38. The computer system of claim 37, wherein said processing unit is further operable to set said return index to a default value associated with said default codeword when none of said data records having said child flag not set matches said search key.

39. The computer system of claim 38, wherein said codeword further includes a default flag, said processor being further operable to retrieve said default codeword within said array of next-level codewords when said default flag is set.

40. The computer system of claim 39, further comprising:
a childless counter, said processing unit being operable to increment said childless counter for each of said data records having said child flag not set that is processed, said result index equaling a counter value of said childless counter.

41. The computer system of claim 40, wherein said processing unit is further operable to set said counter value of said childless counter to said default value when none of said data records having said child flag not set matches said search key.

42. A method for traversing a bonsai tree representing at least a portion of a prefix tree, the portion covering two or more nodes of said prefix tree, said method comprising the steps of:
storing a codeword representing said bonsai tree within a memory, said codeword having a list of data records therein, each of said data records within said list having a variable length match field therein storing a prefix key, each said prefix key being associated with a respective twig consisting of an edge of said bonsai tree and a select one of the two or more nodes that the edge leads to, said list of data records including said prefix key for each said respective twig within the portion of the prefix tree covered by said codeword;
retrieving said codeword from said memory in a single memory read operation; and
processing said codeword using a search key.

43. The method of claim 42, wherein said step of processing further comprises the step of:
processing each of said data records within said codeword in a sequential order.

44. The method of claim 43, wherein said step of storing further comprises the step of:
storing a twig type field within each of said data records, each said twig type field containing a child flag indicating whether said select node of said respective twig has at least one child node and a sibling flag indicating whether said select node of said respective twig has at least one right sibling node.

45. The method of claim 44, wherein said step of processing further comprises the step of:
comparing each said prefix key within each of said data records with said search key.

46. The method of claim 45, wherein said step of comparing further comprises the step of:
determining whether said prefix key within a first one of said data records matches said search key.

47. The method of claim 46, wherein said step of processing further comprises the steps of:
ignoring a next one of said data records in said sequential order when said child flag and said sibling flag of said first data record are set and said prefix key within said first data record does not match said search key; and
ignore an additional one of said data records in said sequential order when said child flag of said next data record is set or said child flag of said next data record is not set, but said sibling flag of said next data record is set.

48. The method of claim 47, wherein said step of processing further comprises the steps of:
incrementing an ignore counter when said child flag and said sibling flag of said first data record are set and said prefix key within said first data record does not match said search key;
decrementing said ignore counter after processing said next data record;
incrementing said ignore counter when said child flag of said next data record is set or said child flag of said next data record is not set, but said sibling flag of said next data record is set; and
decrementing said ignore counter after processing said additional data record.

49. The method of claim 48, wherein said step of processing further comprises the step of:
processing said next data record and said additional data record by analyzing said twig type field without comparing said prefix key within said next data record and said additional data record with said search key.

50. The method of claim 45, wherein said step of processing further comprises the step of:
enumerating each of said data records where said child flag is not set.

51. The method of claim 50, wherein said step of storing further comprises the step of:
storing a pointer within said codeword for pointing to an array of next-level codewords for each said of said data records that does not have said child flag set, each said next-level codeword within said array of next-level codewords representing an additional bonsai tree of said prefix tree or resulting data.

52. The method of claim 51, wherein said step of processing further comprises the steps of:
returning a result index indicating the number of a matching one of said data records having said child flag not set that matches said search key;
determine said next-level codeword within said array of next-level codewords associated with said matching data record using said result index; and
retrieving said next-level codeword associated with said matching data record.

53. The method of claim 52, wherein said step of storing further comprises the step of:
storing a default codeword representing default data within said array of next-level codewords, said default data being associated with an additional node outside of the portion of the prefix tree covered by said codeword.

54. The method of claim 53, wherein said step of returning said result index further comprises the step of:
setting said return index to a default value associated with said default codeword when none of said data records having said child flag not set matches said search key.

55. The method of claim 54, wherein said step of returning said result index further comprises the step of:
incrementing a childless counter for each of said data records having said child flag not set that is processed, said result index equaling a counter value of said childless counter.

56. The method of claim 55, wherein said step of setting said result index further comprises the step of:
setting said counter value of said childless counter to said default value when none of said data records having said child flag not set matches said search key.
